(19) United States
(12) Patent Application Publication
(10) Pub. No.: US 2023/0356031 A1
(43) Pub. Date: Nov. 9, 2023

(54) APPARATUS AND METHOD FOR MONITORING CLIMBERS

(71) Applicant: Alex Bull, Portland, OR (US)

(72) Inventor: Alex Bull, Portland, OR (US)

(21) Appl. No.: 18/140,482

(22) Filed: Apr. 27, 2023

Related U.S. Application Data
(60) Provisional application No. 63/337,733, filed on May 3, 2022.

(51) Int. Cl. A63B 24/00

(52) U.S. Cl. CPC A63B 24/0062; A63B 2220/14; A63B 2220/62; A63B 2225/54

(57) ABSTRACT

A system and method for monitoring the progress of a climb made by a climber as the climber climbs a climbing surface is provided. One embodiment employs a radio frequency identification (RFID) climber tag, carried by the climber, that emits a signal that is detectable by each one of a plurality of RFID tag readers that are each located at a known location on the climbing surface along a predefined climbing route. The RFID climber tag is associated with an identity of the climber.

### PRIORITY CLAIM

This application claims priority to copending U.S. Provisional Application, Ser. No. 63/337,733, filed on May 3, 2022, entitled Apparatus and Method For Monitoring Climbers, which is hereby incorporated by reference in its entirety for all purposes.

### BACKGROUND OF THE INVENTION

Climbers are individuals who climb objects as a hobby. Climbers typically climb mountains, naturally occurring rock walls such as found in canyons or on mountains, and/or man-made climbing walls. Typically, man-made climbing walls are available for use at a climbing facility or a gym.

However, there are difficulties for a climber and/or the climbing wall facility operator to track and/or monitor the climbing efficiency of the climber and/or track the particular climbing routs taken by the climber. For example, the climber may repeat a particular climbing wall route to improve their climbing skills and/or to work on reducing the time required to complete a particular climbing wall route.

Typically, a climbing wall may have multiple climbing wall routes of varying difficulty. The climber and/or the facility operator may want to track which particular climbing wall routes have been attempted and/or successfully completed by a particular climber.

In the arts of radio frequency identification (RFID) technologies, gathering information about an object of interest using a RFID tag (that emits a wireless signal that includes a RFID identifier) and a RFID tag reader (which receives the wireless signal from the RFID tag) is well known. However, applying RFID technology to track and monitor the performance of a climber presents unique difficulties.

One prior art method that monitors a climber employs a RFID reader secured to the climber. RFID tags are located at known locations on the climbing wall. However, affixing an RFID tag reader to the climber may present a hazard to the climber in that the RFID reader, and/or the carrying means, may snag or catch on protrusions on the climbing wall.

Further, the RFID tag reader is relatively expensive (as compared to the RFID tag cost). And, different RFID systems used at different climbing wall facilities may be incompatible with each other.

And, data is acquired by the climber's RFID reader. Only after the climb has been completed can the acquired data be accessed from the climber's RIFD reader (absent costly communication technologies).

Accordingly, in the arts of recreational climbing, there is a need in the arts for improved methods, apparatus, and systems for monitoring a climber's performance using RFID technology.

### SUMMARY OF THE INVENTION

Embodiments of the climber monitoring system provide a system and method for monitors the progress of a climb made by a climber as the climber climbs a climbing surface. One embodiment employs a radio frequency identification (RFID) climber tag, carried by the climber, that emits a signal that is detectable by each one of a plurality of RFID tag readers that are each located at a known location on the climbing surface along a predefined climbing route. The RFID climber tag is associated with an identity of the climber.

### BRIEF DESCRIPTION OF THE DRAWINGS

The components in the drawings are not necessarily to scale relative to each other. Like reference numerals designate corresponding parts throughout the several views.

FIG. 1 is a perspective diagram of a climber monitoring system that employs a plurality of radio frequency identification (RFID) readers that are configured to be secured to a climbing surface.

FIG. 2 is a block diagram of selected components of a climber monitoring system.

### DETAILED DESCRIPTION

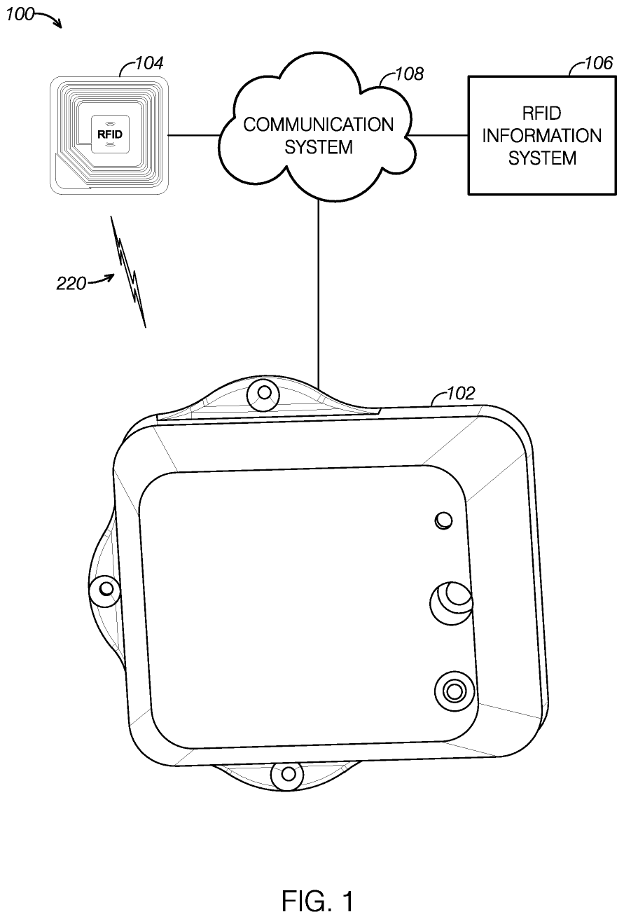

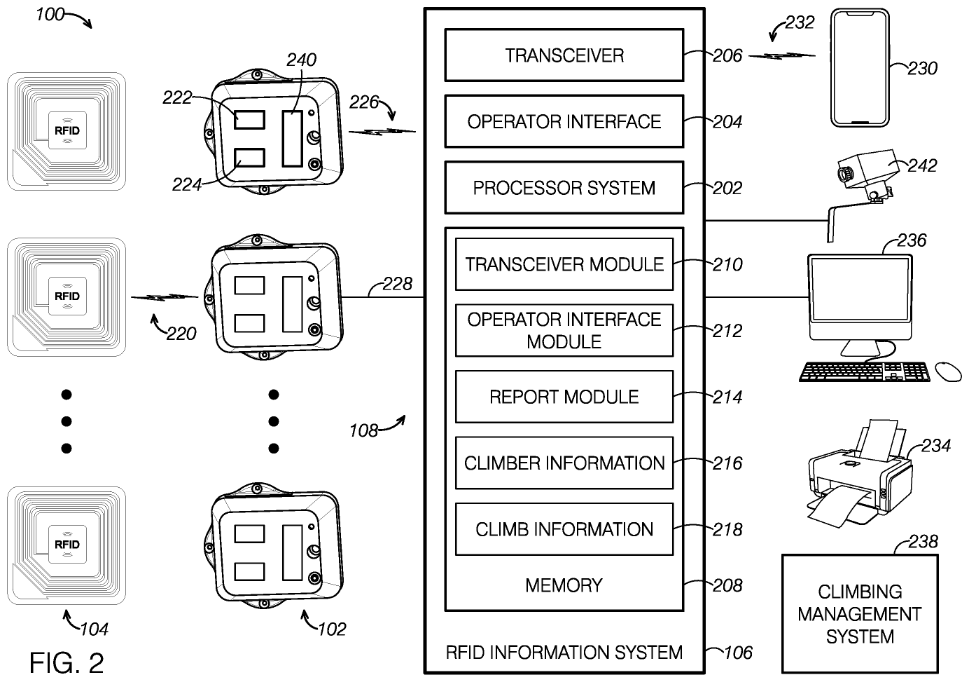

FIG. 1 is a perspective diagram of a climber monitoring system 100 that employs a plurality of radio frequency identification (RFID) readers 102 that are configured to be secured to a climbing surface. FIG. 2 is a block diagram of selected components of a climber monitoring system 100. Embodiments of the climber monitoring system 100 comprise one or more RFID climber tag readers 102, a plurality of RFID climber tags 104, and RFID information system 106. The plurality of RFID climber tag readers 102, the plurality of RFID climber tags 104, and the RFID information system 106 are communicatively coupled to each other via a communication network 108.

The disclosed systems and methods for a climber monitoring system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for a climber monitoring system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire based connector, whether directly or indirectly through a communication network 108. “Controllably coupled” means that an electronic device controls the operation of another electronic device.

A “transceiver” is generically referred to herein as an electronic communication device that is known in the communication arts and that is configured to receive signals and/or emit signals. The signals may be wireless type signals or may be wire-based type signals.

Returning to FIG. 1, the example RFID climber tag reader 102 has a plurality of protruding tabs with apertures (holes) that are configured to receive bolts, nuts, nails, rivets, push pins, or the like for attaching the RFID climber tag reader 102 to a climbing surface. Alternatively, or additionally, a permanent or semi-permanent adhesive may be used to secure the RFID climber tag reader 102 to a climbing surface. The climbing surface may be a man-made climbing wall and/or rope wall, or may be a natural rock face surface.

The illustrated RFID climber tag reader 102 is covered with a durable protective cover made of a rigid or semi rigid material, such as plastic, metal or the like. Preferably, the cover has a low profile and/or rounded edges so as to be snag free to improve safety of climbers.

However, in some embodiments, the cover may also function as a climbing hold, hand hold, and/or foot hold that is attached to the surface of a climbing wall. A climbing hold is an outward protruding member secured to the climbing wall. When used as a hand hold, the climbing hold is grasped by the climber. A foot hold is an outward protrusion that the climber uses their feet to climb upward. In practice, a hold may be used as a hand hold and a foot hold by the climber. In some embodiments, the cover may also function as a protection point for attaching a carabiner, a belaying rope, or climbing rope.

Returning to FIG. 2, the non-limiting exemplary RFID information system 106 comprises a processor system 202, an operator interface 204, a transceiver 206, and a memory 208. The memory 208 comprises portions for storing the transceiver module 210, the operator interface module 212, the report module 214, the climber information 216, and the climb information 218. In some embodiments, transceiver module 210, the operator interface module 212, and/or the report module 214 may be integrated together, and/or integrated with other logic. In other embodiments, some or all of these memory and other data manipulation functions may be provided by using a remote server or other electronic devices suitably connected via the Internet or otherwise to a client device. Other embodiments of the RFID information system 106 may include some, or may omit some, of the above-described components. Further, additional components not described herein may be included in alternative embodiments

The climber monitoring system 100 employs a plurality of RFID climber tag readers 102 secured to the climbing surface. A plurality of RFID climber tag readers 102 may be placed along a particular climbing route to monitor the performance of the climber. Other RFID climber tag readers 102 may be placed along other climbing routes that are defined over the climbing surface.

A climber is in possession of one of the plurality of RFID climber tags 104. Each RFID climber tag 104 is associated with a unique identifier (ID) that is associated with, and that identifies, that particular RFID climber tag 104. A wireless signal emitted by the RFID climber tag 104 includes information corresponding to the unique ID of that particular RFID climber tag 104. Prior to the climb, information corresponding to the identity of the climber is associated with their RFID climber tag 104, and the associated climber identity is stored in the climber information 216 of the memory 208.

In practice, the climber carries one of the plurality of RFID climber tags 104 with them during their climb. In a non-limiting example embodiment, the RFID climber tag 104 is embedded on a card that is easily and safely carried by the user in their clothes pocket or a pack. Alternatively, the RFID climber tag 104 may be clipped to the user's clothes. Alternatively, the RFID climber tag 104 may be included in a flexible, or semi flexible, fabric. An adhesive may be used to secure the RFID climber tag 104 to the user's clothes or body.

In a preferred embodiment, the RFID climber tag 104 is flat and is relatively small. Accordingly, there is minimal likelihood that the RFID climber tag 104 can create a safety hazard (as contrasted with other systems wherein the climbing user carries a larger RFID in a legacy system).

The RFID climber tag 104 continuously emits a short range wireless signal 220. When the RFID climber tag 104 is in proximity to one of the RFID climber tag readers 102 by some minimum predefined detection distance, a transceiver 222 within the RFID climber tag reader 102 detects the emitted wireless signal 220. (The predefined detection distance is interchangeably referred to herein as a detection range, which is typically characterized as a circular region with a radius equal to the distance of the detection range.) The RFID climber tag 104 may be active (includes a power source used to generate the emitted wireless signal 220) or passive (includes an antenna that receives power from a nearby RFID climber tag reader 102). Any RFID climber tag 104 and/or RFID climber tag reader 102 now known or later developed may be used by the various embodiments, and are intended to be protected by the accompanying claims.

In the various embodiments, a minimum detection distance is predefined such that a RFID climber tag 104 is detected by a particular RFID climber tag reader 102 only when the RFID climber tag 104 is within the predefined detection distance of the RFID climber tag reader 102. The detection distance is specifically defined to be relatively short so that the climber, having an RFID climber tag 104, is known to be at (or in proximity to) the detecting RFID climber tag reader 102. For example, the minimum predefined detection distance may be eighteen inches. However, any suitable predefined detection distance may be used such that detection of the wireless signal 220 indicates that the climbing user is proximate to a particular one of the RFID climber tag readers 102 (and also not be detectable by the other RFID climber tag readers 102 located along a climbing route). Preferably, the RFID climber tag 104 is detectable by only one of the RFID climber tag readers 102 located along a climbing route. The wireless signal 220 may be a short range, low power radio frequency signal. Alternatively, the wireless signal 220 may be a magnetic signal.

In a preferred embodiment, prior to the climb, a particular RFID climber tag 104 is associated with the identity of the climber (the user). The processor system 202, executing the operator interface module 212, receives input pertaining to the climber entered by a facility operator who is operating the RFID information system 106. The received climber information is stored into the climber information 216 portion of memory 208. Also, the time and date of association of the climber with the RFID climber tag 104 may be stored by the RFID information system 106. After the climber is done climbing, the RFID climber tag 104 may be reused at a later time by reassigning the RFID climber tag 104 to a different climber. Alternatively, the climber may retain the RFID climber tag 104 for later use.

In an alternative embodiment, the RIFD tag 104 may be disposed on a flexible substrate or fabric with an adhesive backing (interchangeably referred to herein as a RFID climber tag 104). Here, the RFID climber tag 104 may be secured to the climber's clothing or equipment using the adhesive. After use, the used RFID climber tag 104 can be easily removed and optionally disposed of. This embodiment has the advantage that a plurality of pre-printed adhesive RFID climber tags 104 can be assigned as needed for each climber at the start of their climb, and the climber and/or facility operator do not need to be concerned with RFID tag retrieval after climbing has been completed. (This is an unexpected advantage over legacy systems wherein the climber and/or facility operator must keep track of the RFID climber tag reader 102 being carried by the climber.)

Each of the plurality of RFID climber tag readers 102 are secured at a known, predetermined location on the climbing surface. Alternatively, an RFID climber tag reader 102 may be secured to another object proximate to the climbing surface and/or climbing route. Preferably, the plurality of RFID climber tags 104 are installed by the climbing wall facility operator prior to a climb by the climber. The RFID climber tag readers 102 may include one or more batteries as a power source, and/or may be connected to a power source using a suitable wire connector.

Alternatively, another party, or even the climber, may install the one or more RFID climber tag readers 102 along a climbing route. For example, the RFID climber tag readers 102 may be installed on a natural rock climbing surface by a first climber so that subsequent climbers are detected during their later climb. Here, the RFID climber tag readers 102 may include one or more batteries as a power source.

When the climber starts their climb, an RFID climber tag reader 102 located at the start (beginning) of the climb detects the presence of the wireless signal 220 emitted from the climber's RFID climber tag 104. Preferably, a climbing route has been defined by location of a plurality of climbing holds on the climbing wall. A start time corresponding to the time of detection of the start of the climb by the first RFIG climber tag reader 102 may be determined and saved.

In the various embodiments, the RFID climber tag readers 102 are communicatively coupled to the RFID information system 106, via a suitable communication system 108, using a second transceiver 224. For example, a wireless signal 222 may be communicated from the transceiver 224 in the RFID climber tag reader 102 to the transceiver 206 in response to that particular RFID climber tag reader 102 detecting the wireless signal 220 emitted by the RFID climber tag 104. In an example embodiment, the transceiver(s) 222 is configured to wirelessly receive wireless signals 220 from a RFID climber tag 104, and then the transceiver 224 is configured to transmit a wireless radio frequency (RF) communication signal 226 to the transceiver 206 of the RFID information system 106. The signal 226 includes information corresponding to the unique ID associated with the detected RFID climber tag 104.

In the various embodiments, the wireless communication transceivers 206, 224 may operate using a low power communication system, such as a near-field communication system. An example near-field communication is Bluetooth. Any suitable low power and/or near-field communication system now known or later developed may be used in the various embodiments. A low power near-field communication system is suitable because of the close proximity of the RFID climber tag readers 102 to the RFID information system 106.

Alternatively, or additionally, an RFID climber tag reader 102 may be communicatively coupled to the RFID information system 106 using a wire-based connector 228. An unexpected advantage of using wire based connectors 228 is that power may be optionally supplied to the RFID climber tag reader 102 via the connector 228 (or another suitable connector). (This unexpected advantage is not available to legacy systems where the climber carries the RFID climber tag reader 102 during their climb.)

The processor system 202, executing the transceiver module 210, processes information in the received wireless signal 226 and/or signal 228. The received information identifies the particular RFID climber tag reader 102. Further, the signal 226, 228 contains the identity of the RFID climber tag 104 that is in possession of the climber. The processor system 202 associates the received information with the climber and stores the associated information into the climb information 218. Preferably, the time (and optionally the date) that the RFID climber tag reader 102 detected the signal 226, 228, or the time (and optionally the date) that the transceiver 206 received the signal 226, 228, is also stored into the climb information 218.

When the climber is no longer proximate to the detecting RFID climber tag reader 102 as they are climbing the climbing surface, that RFID climber tag reader 102 no longer detects the RFID climber tag 104. In some embodiments, an end of detection signal is transmitted by the RFID climber tag reader 102 to the RFID information system 106. Alternatively, or additionally, the RFID climber tag reader 102 periodically transmits the signal 226, 228 so long as the RFID climber tag 104 remains within the detection distance of that RFID climber tag reader 102. Accordingly, the processor system 202 can determine the duration of time that the climber was in proximity to the detecting RFID climber tag reader 102. Here, the duration is a difference between the first time of detection of the RFID climber tag reader 102 and a last time of detection of the RFID climber tag reader 102.

This determinable climb duration can be an indication of the climber's performance. Here, a short duration can be associated with an effective climb by an experienced climber, whereas a longer climb duration might be associated with a less efficient climb by an inexperienced climber. Further, the climb duration at a particular first RFID climber tag reader 102 during a first climb (made at a first time on a first date) may be compared with the climb duration at the same RFID climber tag reader 102 during a later second time (and/or second date). The difference between the climb durations may then be determined. If the difference between the climb durations decreases, then a determination of a change in the climber's performance may be made.

When the climber has completed the climbing route, all of the information received from the RFID climber tag readers 102 disposed along the route may be associated with that climber and may be stored into the climb information 218. For example, but not limited to, the climber's identity and the time associated with detection of the wireless signal 220 by each of the RFID climber tag readers 102 may be stored for that particular route. Information identifying that route may also be associated with the climb and/or climber, and stored. One skilled in the art appreciates that information may be stored into the climb information 218 for different routes, for different climbers, and even for the same route done by a particular climber at different times.

As an example of a practical use of the climber monitoring system 100, a first RFID climber tag reader may be a first one of the plurality of RFID tag readers that is located at an initial location along the predefined climbing route. A last one of the plurality of RFID tag readers may be located at a last location along the predefined climbing route. A total climb duration may be determined that equals a difference in time between the first time (a start time of a climb) and the second time (a finish time of the climb), wherein the total climb duration corresponds to a total duration that the climber used to complete the predefined climbing route. This total climb duration may be saved. Then, at a later time and/or date, the climber may reclimb the predefined climbing route and a new total climb duration may be determined. A comparison of the two total climb durations may indicate an amount of improvement of the climber over time.

As another example, a plurality of climbers may traverse the predefined climbing route. The total climb duration for each climber may be determined, and then compared with the total climb duration of the other climbers. If a climbing competition is conducted, then the climber with the fasted climb (lowest total climb duration) could be declared as the competition winner. If a climber's ability is associated with a skill level (novice, intermediate, expert), then the climber's performance may be compared within their skill level grouping to rank the climbers in each skill level grouping.

In an example embodiment, to indicate completion of a climb, the user may actuate (push) a button or other actuator located at the end of the climbing route. Once actuated, a signal corresponding to the end of the climb is sent to the RFID information system 106. The RFID information system 106 can then store the climbing information associated with completion of the climb route and information identifying the climber into the climb information 218 portion of memory 208. For example, but not limited to, the time of completion of the climbing route by the climber may be stored.

Alternatively, or additionally, a particular one or more of the RFID climber tag readers 102 may be designated as the last one of the plurality of RFID climber tag readers 102 disposed at an end location along the climbing route, or at another location on a climbing wall, such as at a designated location at a top of the climbing wall where the climber knows that they have to approach to denote the conclusion of their climb (similar to the finish line of a racing track or the like). This last RFID climber tag reader(s) 102 would sense the climber's RFID climber tag 104. A last time may be associated with the time that the last RIFD climber tag reader(s) 102 detected the climber's RFID climber tag 104, wherein the last time corresponds to a time of the end or the climb.

In an example embodiment, two RFID climber tag readers 102 are defined as the last RFID climber tag readers 102 and cooperatively define a digital barrier. Here, the digital barriers corresponds to the intersections of the two predefined detection ranges of the two RFID climber tag readers 102. The sensing of the communication signal 220 emitted by the climber's RFID climber tag 104 would be reported to the RFID information system 106. The RFID information system 106 could then store the information that identifies the climber (based on the sensed identifier of the RFID climber tag 104) and the time of the detection (which corresponds to the time of completion of the climbing route).

In some embodiments, a climb score may be assigned to the climber based on the duration of the climb time, which is determined based on when the first RFID climber tag reader 102 detects the climber's RFID climber tag 104 and the time that the last RFID climber tag reader 102 detects the climber's RFID climber tag 102. Scores may also be determined based on a determined duration that the climber is at each of the RFID climber tag readers 102, at selected ones of the RFID climber tag readers 102, or at a predefined one of the RFID climber tag readers 102.

Climbing route segments may be defined for portions of a climbing route over the climbing surface. A climbing route segment is defined by identifying a plurality of segment RFID climber tag readers 102 that are serially aligned in an adjacent manner along a portion of interest of a climbing route. For example, several serially aligned adjacent RFID climber tag readers 102 may be located along the path of each climbing segment. In practice, a particular feature of interest on the climbing wall, such as a very difficult to climb overhang, may be defined as a segment. A segment duration may be determined from a first segment time associated with detection of the RFID climber tag 104 at the first one of the segment RFID climber tag readers 102, and a last segment time associated with a last one of the segment RFID climber tag readers 102. Additionally, climbing durations between adjacent RFID climber tag readers 102 may be determined, stored, and reported. A segment score for each climbing segment may be determined based on the time the climber takes to travel that climbing segment.

In some embodiments a station score may be determined for each climbing station that has a single RFID climber tag reader 102. The station score may be based on the duration of time that the RFID climber tag reader 102 is able to detect the climber's RFID climber tag 104.

For example, a climb score of 100 may be determined when the climber completes the climb within some tolerance of a predefined climb duration. The climb score may be adjusted upward if the climber's time is less than the predefined climb time, and may be decreased in the climb time is greater that the predefined climb time. Climb scores, segment scores, and/or station scores may be adjusted by the determined duration that the climber is at a particular one of the RFID climber tag readers 102.

Over time, a log of the climb durations performed by the climber may be acquired since climb duration information, climb scores, segment scores, and/or station scores for a particular climb route are determined and saved. A report may be provided to the climber and/or facility operator describing completed climbs and other attributes, such as date/time of a particular climb, the duration required to complete a particular climb, climb scores, segment scores, and/or station scores. The climber can compare their scores to see if there is an improvement in their climb durations and/or scores over time. Improved climb durations, climb scores, segment scores, and/or station scores may be associated with improving climbing skills of the climber.

The facility operator may assess the usage of particular climbing routes based on a generated report for a plurality of different climbers. Here, information from a plurality of climbers using the same route would have been acquired and stored. The information may be used to alter climbing routes, change location of hand holds, foot holds, or other climbing surface features.

The RFID information system 106 is configured to provide various report information to the climber and/or the facility operator. The processor system 202, executing the operator interface module 212, receives a report request from the facility operator or another individual (such as the climber) via the operator interface 204. The request may be for information pertaining to one or more climbs by a specified climber, information pertaining to a particular route, information pertaining to routes and/or climbs performed during a specified period of time, etc.

The processor system 202, executing the report module 214, accesses the climb information 218 to acquire the requested information. A report is then generated and communicated to the facility operator, the climber, and/or another party. Reports may include statistical information pertaining to a route. For example, the report may inform the climber that they completed the route in average time. Or, the report may indicate that the climber was faster than, or was slower than, the average, the median and/or the mode climb durations for that route.

In an example embodiment, the RFID information system 106 may be communicatively coupled to an electronic device of the climber, such as a smart phone 230. The report may be communicated from the transceiver 206 to the user's cell phone 230 via a wireless signal 232, such as used by a Wi-Fi or a cell phone system. The climber may then view the report on the display of their cell phone 230.

Alternatively, or additionally, the report may be printed using a printing device 234 and/or presented on a display 236 located at the climbing facility. Alternatively, or additionally, the report may be communicated from the transceiver 206 to a remote device, such as a personal computer or a climbing management system 238. The climbing management system 234 may be configured to acquire climb information from multiple RFID information systems 106.

In an example application of reporting stored climbing information, the time to complete the climbing route, interchangeably referred to herein as the total climb duration, may be determined based on the detected start time and the detected ending time for a particular route. Durations for route segments may also be determined. This information may be used to generate a climb report by the processor system 202 executing the report module 214.

Some RFID climber tag readers 102 may include optional electronics 240. For example, pressure sensors 240 may detect hand hold or foot hold pressure applied by the climber during their climb. A microphone 240 may be used to detect sounds made by the climber. For example, a climber's request for help may be communicated to the RFID information system 106. A speaker 240 may be used to emit sounds that would be heard by the user. For example, instructions on how to proceed may be provided to the climber by the RFID information system 106.

Image capture devices, such as a video camera 242, may acquire image information that shows a climber climbing a known route. Since the image information includes time stamp information for each video image, a video portion may be generated based upon a predefined duration about one or more particular RFID climber tag readers 102. For example, a climbing route segment may have been predefined. The times that the climber was climbing that segment are determinable based on the detection times of the RFID climber tag 104 by the RFID climber tag readers 102 along that segment. Video image times may then be used to create a video of the climber as they are climbing that segment by selecting video segments with recording times that correspond to the detection times of the RFID climber tag 104. Optionally, some duration of time around the detection time of the RFID climber tag 104, such as several seconds or minutes, may be used for defining the times of the video. A report that is generated by the RFID information system 106 may then include the generated and saved video information associated with the same time of the climb. The climber or another person can later view the video and/or view selected still images (based on time of interest or locations of interest). The video and/or image information can then be later presented to the facility operator, the climber, a teacher, and/or another person. In some instances, videos of different climbs by that climber over the same segment, and/or saved videos of climbs over the same segment by other climbers, may be presented.

In some embodiments a plurality of video cameras 242 may be oriented so as to acquire videos of different areas of the climbing surface. Initiation of video recording by any particular video camera 242 may be initiated when a RFID climber tag 104 is detected at a particular one of the RFID climber tag readers 102. Here, the RFID information system 106 receives the signal 226, 228 transmitted by the detecting RFID climber tag reader 102. In response to receiving the signal 226, 228, the RFID information system 106 operates the video camera 242 to start the video recording, which is saved into the climb information 218. The video may also be associated with the climber since the climber's identity is known. When a last one of the RFID climber tag readers 102 detects the RFID climber tag 104, then the RFID information system 106 may operate the video camera 242 to end the video recording process.

The climb report may also include suggestions or recommendations for improving climbing techniques. For example, a teacher may review the climb report. The teacher may then update the climb report by adding comments, videos, images or other information of interest. The updated climb report may then be saved and/or may be communicated to a device used by the climber. The climber may then study the suggestions or recommendations made by the teacher. Later, the climber may repeat the same climb. The climb report for that subsequent climb may then be reviewed by the teacher and/or the climber to identify improvements made by the climber in their subsequent climb.

In some embodiments, the RFID climber tag readers 102 may be built into the climbing wall, or even behind the climbing wall, so as to not be visible to the climber. Here, such hidden RFID climber tag readers 102 will not be distracting to the climber, and therefore improve climbing safety.

It should be emphasized that the above-described embodiments of the climber monitoring system 100 are merely possible examples of implementations of the invention. Many variations and modifications may be made to the above-described embodiments. All such modifications and variations are intended to be included herein within the scope of this disclosure and protected by any later filed claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A climber monitoring method that monitors progress of a climb made by a climber as the climber climbs a climbing surface, wherein a radio frequency identification (RFID) climber tag, carried by a climber, emits a first signal that is detectable by each one of a plurality of RFID tag readers that are each located at a known location on the climbing surface along a predefined climbing route, and wherein the RFID climber tag is associated with an identity of the climber, the method comprising:
detecting the first signal emitted by the RFID climber tag by a first RFID climber tag reader that is one of the plurality of RFID tag readers, wherein the first signal emitted by the RFID climber tag is detected only when the RFID climber tag is within a predefined detection distance of the detecting first RFID climber tag reader;
emitting a second signal from a first transceiver residing in the detecting first RFID climber tag reader in response to detecting the first signal emitted from the RFID climber tag, wherein the second signal includes information associated with an identifier of the RFID climber tag;
receiving the second signal at a second transceiver residing in an RFID information system;
determining, at the RFID information system, the identifier of the RFID climber tag;
accessing, from a memory residing at the RFID information system, the identity of the climber who is associated with the RFID climber tag; and
storing, in the memory, information corresponding to the identity of the climber, the known location of the first RFID climber tag reader, and a first time corresponding to the detection of the first signal by the first RFID climber tag reader.

2. The method of claim 1, further comprising:
continuing to detect the second signal from the first transceiver residing in the detecting first RFID climber tag reader so long as the first signal emitted from the RFID climber tag is detected by the first RFID climber tag reader;
periodically communicating the second signal from the first transceiver residing in the detecting first RFID climber tag reader;
periodically receiving the second signal at the second transceiver residing in the RFID information system;
determining a last time that a last one of the periodically received second signals is received at the second transceiver; and
determining a duration that the RFID climber tag was detected by the first RFID climber tag reader,
wherein the duration equals a difference in time between the first time of receiving the second signal and the last time of receiving the second signal.

3. The method of claim 2, wherein the duration is a first duration, wherein the climber who climbs the climbing surface is making a first climb, the method further comprising:
determining a second duration that the RFID climber tag has been detected by the first RFID climber tag reader during a time of a second climb that is different than a time of the first climb; and
comparing the first duration with the second duration,
wherein a difference between the first duration and the second duration is indicative of a change in performance of the climber.

4. The method of claim 1, further comprising:
monitoring, at the first RFID climber tag reader, when the first signal emitted from the RFID climber tag is no longer detected by the first RFID climber tag reader;
emitting a third signal from the first transceiver residing in the detecting first RFID climber tag reader in response to no longer detecting the first signal emitted from the RFID climber tag;
receiving the third signal at the second transceiver residing in the RFID information system;
determining a last time based corresponding to a time that the third signal was emitted; and
determining a duration that the RFID climber tag has been detected by the first RFID climber tag reader,
wherein the duration equals a difference in time between the first time and the last time.

5. The method of claim 4, wherein the duration is a first duration, wherein the climber who climbs the climbing surface is making a first climb, the method further comprising:
determining a second duration that the RFID climber tag has been detected by the first RFID climber tag reader during a time of a second climb that is different than a time of the first climb; and
comparing the first duration with the second duration,
wherein a difference between the first duration and the second duration is indicative of a change in performance of the climber.

6. The method of claim 1, further comprising:
detecting the first signal emitted by the RFID climber tag by a second RFID climber tag reader that is one of the plurality of RFID tag readers, wherein the first signal emitted by the RFID climber tag is detected only when the RFID climber tag is within the predefined detection distance of the detecting second RFID climber tag reader;
emitting a third signal from a third transceiver residing in the detecting second RFID climber tag reader in response to detecting the first signal emitted from the RFID climber tag, wherein the third signal includes the information associated with the identifier of the RFID climber tag;
receiving the third signal at the second transceiver residing in the RFID information system;
determining, at the RFID information system, the identifier of the RFID climber tag;
accessing, from the memory residing at the RFID information system, the identity of the climber who is associated with the RFID climber tag;
accessing, from the memory residing at the RFID information system, information corresponding to the known location of the RFID climber tag;
and
storing, in the memory, information corresponding to the identity of the climber, the known location of the second RFID climber tag reader, and a second time corresponding to the detection of the third signal by the second RFID climber tag reader.

7. The method of claim 6, further comprising:
determining a duration that equals a difference in time between the first time and the second time.

8. The method of claim 7,
wherein the first RFID climber tag reader is a first one of the plurality of RFID tag readers that is located at an initial location along the predefined climbing route,
wherein the second RFID climber tag reader is a last one of the plurality of RFID tag readers that is located at a last location along the predefined climbing route, and
wherein the determined duration that equals a difference in time between the first time and the second time corresponds to a total climb duration that the climber used to complete the predefined climbing route.

9. The method of claim 8, wherein the second RFID climber tag reader is a first last one of the plurality of RFID tag readers that is located at a first last location proximate to the last location along the predefined climbing route, wherein a third RFID climber tag reader is a second last one of the plurality of RFID tag readers that is located at a second last location proximate to the last location along the predefined climbing route, wherein a digital barrier is defined by an intersection of a first detection range of the second RFID climber tag reader and a second detection range of the third RFID climber tag reader; the method comprising:
detecting the RFID climber tag concurrently by the second RFID climber tag reader and the third RFID climber tag reader; and
determining that the climber has crossed the digital barrier in response to detecting the RFID climber tag concurrently by the second RFID climber tag reader and the third RFID climber tag reader.

10. The method of claim 8, wherein the total climb duration is a first total climb duration, wherein the climber who climbs the climbing surface is making a first climb, the method further comprising:
determining a second total climb duration that equals a difference in time between a first time of a subsequent climb and a second time of the subsequent climb; and
comparing the first total climb duration with the second total climb duration,
wherein a difference between the first total climb duration and the second total climb duration is indicative of a change in performance of the climber.

11. The method of claim 1, wherein the climber is a first climber, the method further comprising:
associating the RFID climber tag with a second climber after the first climber has completed the predefined climbing route, wherein an identity of the second climber and the identifier of the RFID climber tag are stored in the memory;
detecting the first signal emitted by the RFID climber tag by the first RFID climber tag reader;
emitting a third signal from the first transceiver residing in the detecting first RFID climber tag reader in response to detecting the first signal emitted from the RFID climber tag, wherein the third signal includes information associated with an identifier of the RFID climber tag;
receiving the third signal at the second transceiver residing in the RFID information system;
determining, at the RFID information system, the identifier of the RFID climber tag;
accessing, from a memory residing at the RFID information system, the identity of the second climber who is currently associated with the RFID climber tag; and
storing, in the memory, information corresponding to the identity of the second climber, the location of the first RFID climber tag reader, and a second time corresponding to the detection of the first signal by the first RFID climber tag reader.

12. The method of claim 1, wherein the climber is a first climber, wherein the predefined climbing route is a first predefined climbing route, and the method further comprising:
associating the RFID climber tag with a second climber after the first climber has completed the predefined climbing route, wherein an identity of the second climber and the identifier of the RFID climber tag is stored in the memory;
detecting the first signal emitted by the RFID climber tag by the second RFID climber tag reader, wherein the second RFID climber tag reader is at a known location along a second predefined climbing route that is different from the first predefined climbing route;
emitting a third signal from the first transceiver residing in the detecting first RFID climber tag reader in response to detecting the first signal emitted from the RFID climber tag, wherein the third signal includes information associated with an identifier of the RFID climber tag;
receiving the third signal at the second transceiver residing in the RFID information system;
determining, at the RFID information system, the identifier of the RFID climber tag;
accessing, from a memory residing at the RFID information system, the identity of the second climber who is currently associated with the RFID climber tag; and
storing, in the memory, information corresponding to the identity of the second climber, the location of the second RFID climber tag reader, and a second time corresponding to the detection of the first signal by the second RFID climber tag reader.

13. The method of claim 1, wherein prior to a start of the climb by the climber, the method further comprises:
receiving first input information pertaining to the climber;
storing the first input information into the memory,
wherein the input information is entered by a facility operator who is operating the RFID information system, and
wherein the input information includes the identity of the climber;
receiving second input information identifying the RFID climber tag;
associating the first input information pertaining to the climber with the second input information identifying the RFID climber tag; and
storing association information into the memory corresponding to the associated first input information pertaining to the climber and the associated the second input information identifying the RFID climber tag.

14. The method of claim 13, wherein the climber is a first climber, wherein the input information is a first input information, and wherein after the end of the climb by the first climber and prior to a start of the climb by a second climber who is different from the first climber, the method further comprises:
receiving a third input information pertaining to the second climber; and
storing the third input information into the memory,
wherein the second input information is entered by a facility operator who is operating the RFID information system, and
wherein the second input information includes the identity of the second climber;
receiving fourth input information identifying the RFID climber tag;
associating the third input information pertaining to the second climber with the fourth input information identifying the RFID climber tag; and
storing association information into the memory corresponding to the associated third input information pertaining to the second climber and the associated the fourth input information identifying the RFID climber tag.

15. The method of claim 1, further comprising:
defining a climbing route segment, wherein the climbing route segment is a portion of a climbing route;
identifying a plurality of segment RFID climber tag readers that are serially aligned in an adjacent manner along the climbing route segment;
detecting the first signal emitted by the RFID climber tag by a first segment RFID climber tag reader, wherein the first segment RFID climber tag reader is at a first location along the climbing route segment;
emitting a third signal from the first transceiver residing in the detecting first segment RFID climber tag reader in response to detecting the first signal emitted from the RFID climber tag, wherein the third signal includes information associated with an identifier of the RFID climber tag;
receiving the third signal at the second transceiver residing in the RFID information system;
determining, at the RFID information system, the identifier of the RFID climber tag;
accessing, from the memory residing at the RFID information system, the identity of the climber who is currently associated with the RFID climber tag; and
storing, in the memory, information corresponding to the identity of the climber, the location of the first segment RFID climber tag reader, and a first segment time corresponding to the detection of the first signal by the first segment RFID climber tag reader;
detecting the first signal emitted by the RFID climber tag by a last segment RFID climber tag reader, wherein the last segment RFID climber tag reader is at a last location along the climbing route segment;
emitting a fourth signal from the first transceiver residing in the detecting last segment RFID climber tag reader in response to detecting the first signal emitted from the RFID climber tag, wherein the fourth signal includes information associated with an identifier of the RFID climber tag;
receiving the fourth signal at the second transceiver residing in the RFID information system;
determining, at the RFID information system, the identifier of the RFID climber tag;
accessing, from the memory residing at the RFID information system, the identity of the climber who is currently associated with the RFID climber tag;
storing, in the memory, information corresponding to the identity of the climber, the location of the first segment RFID climber tag reader, and a last segment time corresponding to the detection of the first signal by the first segment RFID climber tag reader; and
determining a segment climb duration based on a difference between the first segment time and the last segment time.

16. The method of claim 1, further comprising:
capturing a video of the climb made by the climber as the climber climbs the climbing surface, wherein capturing the video is initiated in response to receiving the second signal at the second transceiver residing in an RFID information system; and
storing the video.

17. A climber monitoring system that monitors progress of a climber as the climber climbs a climbing surface, comprising:
a radio frequency identification (RFID) climber tag that is carried by the climber,
wherein the RFID climber tag emits a first signal that is detectable by each one of a plurality of RFID climber tag readers, and
wherein the RFID climber tag is associated with an identity of the climber;
the plurality of RFID climber tag readers disposed on the climbing surface,
wherein each one of the plurality of RFID climber tag readers are at a known location on the climbing surface along a predefined climbing route, and
wherein each RFID climber tag reader comprises:
a first transceiver configured to detect the first signal emitted by the RFID climber tag only when the RFID climber tag is within a predefined detection distance of a detecting RFID climber tag reader; and
a second transceiver configured to transmit a second signal in response to the first transceiver detecting the first signal, wherein the second signal incudes identity (ID) information that identifies the detecting RFID climber tag reader; and
an RFID information system, the RFID information system comprising:
a third transceiver that receives the second signal emitted by the detecting RFID climber tag reader;
a processor system that determines an identity of the detecting RFID climber tag reader based on the ID information in the second signal that is received by the third transceiver; and
a memory that stores location information associated with the known location of each one of the plurality of RFID climber tag readers, the ID information associated with each one of the plurality of RFID climber tag readers, and identity information corresponding to the identity of the climber who is associated with the RFID climber tag,
wherein the processor system determines the location of the detecting RFID tag reader based on the location information of the detecting RFID tag reader,
wherein the processor system determines the identity of the climber based on the RFID tag identity, and
wherein the location of the detecting RFID climber tag reader, the identity of climber and a time corresponding to the second signal are stored in the memory of the RFID information system.

18. The climber monitoring system of claim 17, wherein the plurality of RFID tag readers comprises:
a first RFID climber tag reader located at a beginning of the predefined climbing route, wherein in response to detecting the first signal emitted by the RFID climber tag, the first RFID climber tag emits its second signal which indicates the start of the climb along the predefined climbing route by the climber; and
a second RFID climber tag reader located at an end of the predefined climbing route, wherein in response to detecting the first signal emitted by the RFID climber tag, the second RFID climber tag emits its second signal which indicates the end of the climb along the predefined climbing route by the climber.

19. The climber monitoring system of claim 18,
wherein in response to receiving the second signal from the first RFID climber tag reader, the processor generates and stores a first time corresponding to the start of the climb along the predefined climbing route by the climber,
wherein in response to receiving the second signal from the second RFID climber tag reader, the processor generates and stores a second time corresponding to the end of the climb along the predefined climbing route by the climber, and
wherein the climber monitoring system comprises:
a report module stored in the memory,
wherein in response to receiving a report request, the processor system determines a total climb duration based on the stored start time and the stored end time, and
wherein the processor, executing the report module, generates a report that includes the total climb duration, and
wherein the second transceiver communicates the report to a remote electronic device.
